(19) United States
(12) Patent Application Publication
(10) Pub. No.: US 2017/0154699 A1
(43) Pub. Date: Jun. 1, 2017

(54) ALUMINUM ALLOY CONDUCTIVE WIRE

(71) Applicant: METAL INDUSTRIES RESEARCH & DEVELOPMENT CENTRE, Kaohsiung City (TW)

(72) Inventors: Ching-Shing Kang, Kaohsiung City (TW); Jing-Shiang Shih, Kaohsiung City (TW); Ruei-Hong Wu, Kaohsiung City (TW)

(21) Appl. No.: 15/349,055

(22) Filed: Nov. 11, 2016

(30) Foreign Application Priority Data
Nov. 30, 2015 (TW) 104139837

(51) Int. Cl. H01B 1/02; H01B 5/02; C22C 21/00

(52) U.S. Cl. CPC H01B 1/023; C22C 21/00; H01B 5/02

(57) ABSTRACT

Aluminum alloy conductive wire consists of 0.5 to 1.0 wt % iron (Fe), 0.05 to 0.3 wt % copper (Cu) and the balance aluminum (Al) plus incidental impurities. The aluminum alloy conductive wire with fine heat resistance and conductivity can apply to wire bonding of high power device.

### FIELD OF THE INVENTION

This invention generally relates to an aluminum alloy conductive wire, more particularly to an aluminum alloy conductive wire with fine heat resistance and conductivity.

### BACKGROUND OF THE INVENTION

Conductive wire made of gold, silver or copper with excellent conductive is usually applied to conventional wire bonding process of power device package. The interface between the wire and the connect pad (e.g. aluminum pad) easily forms intermetallic compound to increase electric resistance and forms voids because of different element diffusion, hence most power device package use aluminum wire for wire bonding now. However, high temperature due to the power device with high density, miniaturization or high output power may soften the aluminum wire to drop from the contact and fail, and furthermore decrease the reliability of the power device.

### SUMMARY

The primary object of the present invention is to provide an aluminum alloy conductive wire which consists of 0.5 to 1.0 wt % iron (Fe), 0.05 to 0.3 wt % copper (Cu) and the balance aluminum (Al) plus incidental impurities.

Wire softening and fail contact result from the high temperature of the power device can be preventable when the aluminum alloy conductive wire of the present invention with fine heat resistance and conductive is applied to wire bonding of power device package, so the reliability of the power device can be improved. Furthermore, the aluminum alloy conductive wire of the present invention also has fine strength and extension.

### DESCRIPTION OF THE DRAWINGS

FIG. 1 is results of thermal mechanical analysis (TMA).

FIG. 2 is pull force results of temperature cycling test (TCT).

FIG. 3 is saturation voltage results of temperature cycling test (TCT).

FIG. 4 is pull force results of highly accelerated temperature and humidity stress test (HAST).

FIG. 5 is saturation voltage results of highly accelerated temperature and humidity stress test (HAST).

### DETAILED DESCRIPTION OF THE INVENTION

An aluminum alloy conductive wire of the present invention consists of 0.5 to 1.0 wt % iron (Fe), 0.05 to 0.3 wt % copper (Cu) and the balance aluminum (Al) plus incidental impurities, wherein iron can improve the strength of the aluminum alloy, and copper solid-soluted in the aluminum alloy can strengthen the aluminum alloy matrix to improve the strength and heat resistance of the aluminum alloy.

Purity aluminum, aluminum-iron alloy and aluminum-copper alloy are firstly melted as a molten alloy liquid firstly in the manufacturing method of the aluminum alloy conductive wire of the present invention, and next the molten alloy liquid is solidified and molded to form an aluminum alloy ingot, and finally the aluminum alloy wire is manufactured by plastic working of the aluminum alloy ingot (e.g. extrusion and stretching), wherein the diameter of the aluminum alloy conductive wire is 0.38 mm in this embodiment, and the aluminum alloy conductive wire can be applied to wire bonding of power device package.

With reference to Table 1 below, that is tensile test results of 0.38 mm conductive wires, and A1 and A2 are control conductive wires (control group) used for comparing with A3 and A4 which are the aluminum alloy conductive wire examples of the present invention, wherein A1 is the conductive wire made of fine aluminum, A2 is the aluminum alloy conductive wire consisting of 0.7 wt % iron, A3 is the aluminum alloy conductive wire consisting of 0.7 wt % iron and 0.1 wt % copper, and A4 is the aluminum alloy conductive wire consisting of 0.7 wt % iron and 0.2 wt % copper. The tensile strength and yield strength of the A3 and A4 both higher than A1 and A2 is clearly identified in the tensile test results (Table 1), so iron and copper in the aluminum alloy can improve the aluminum alloy strength actually. Furthermore, A3 with 0.1 wt % copper and A2 without copper have similar extensions, and A4 with 0.2 wt % copper has higher extension than A1 and A2 without copper, thus it can be seen that the aluminum alloy conductive wire of the present invention actually has fine strength and extension to meet the demand of wire bonding in power device package.

TABLE 1

| | Tensile strength | Yield strength | Extension |
|---|---|---|---|
| 0.38 mm Wire | (kgf) | (kgf) | (%) |
| A1(fine Al) | 0.75 | 0.63 | 24.30 |
| A2(Al—0.7Fe) | 0.85 | 0.70 | 23.50 |
| A3(Al—0.7Fe—0.1Cu) | 1.08 | 0.75 | 23.43 |
| A4(Al—0.7Fe—0.2Cu) | 1.11 | 0.82 | 25.45 |

With reference to Table 2 below which show the results of conductivity test, hardness test and thermal mechanical analysis, the conductivity of the aluminum alloy conductive wire of the present invention is equal or higher than 62% IACS according to the results of the conductivity test, and preferably, the conductivity of the aluminum alloy conductive wire is between 62 and 63% IACS. Hence the aluminum alloy conductive wire can meet the demand of wire bonding for power device package because of fine conductivity. According to the results of hardness test, the hardness of the example wires (A3 and A4) are both higher than the control wires (A1 and A2), and the hardness of the aluminum alloy conductive wire is not higher than 35 Hv, thus chip breakage and poor connection caused by overhard wire are preventable when applying the aluminum alloy conductive wire of the present invention to wire bonding. Preferably, the hardness of the aluminum alloy conductive wire is not higher than 30 Hv.

TABLE 2

| | Conductivity | Hardness | Soften temperature |
|---|---|---|---|
| 0.38 mm Wire | (% IACS) | (Hv) | (° C.) |
| A1 (fine Al) | 63.8 | 24 | 105 |
| A2 (Al—0.7Fe) | 63.0 | 26 | 155 |
| A3 (Al—0.7Fe—0.1Cu) | 62.6 | 27 | 175 |
| A4 (Al—0.7Fe—0.2Cu) | 62.1 | 29 | 185 |

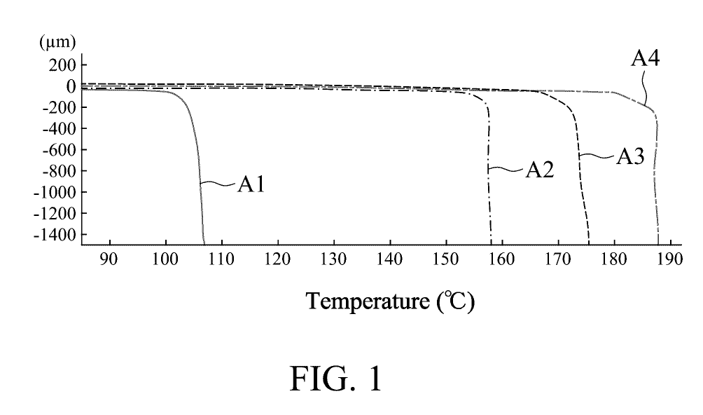

With reference to Table 2 above and FIG. 1, the soften temperature of the conductive wires A1-A4 are measured by thermomechanical analyzer (TMA) in thermal mechanical analysis. It can be seen according to the results of thermal mechanical analysis, the soften temperature of the example wires (A3 and A4) are both higher than the control wires (A1 and A2), wherein the soften temperature of the aluminum alloy soften temperature wire of the present invention is equal or higher than 175° C., and preferably is between 175 and 190° C. Owing to the soften temperature of A3 and A4 wires are significantly higher than A1 and A2 wires, the aluminum alloy conductive wire of the present invention has excellent heat resistance actually, and the conductive wire softening and dropping from the contact result from the heating of the power device can be prevented when the aluminum alloy conductive wire is applied to wire bonding of power device.

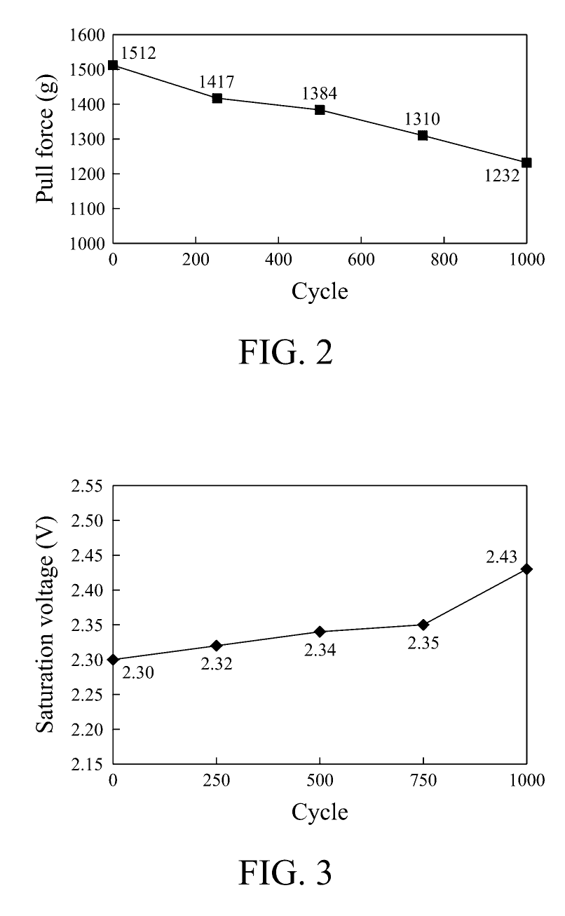

With reference to FIGS. 2 and 3, they show the results of temperature cycling test (TCT, JESDC Standard JESD22-A104D). A3 conductive wire is wire bonded to the pad of the power device for forming the contact firstly, next the power device with A3 conductive wire after wire bonding is placed in temperature controlled chamber for 1000 temperature cycles (Min: −55° C., Max: 125° C.), wherein the cycle rate is 2-3 cycles per hour and each cycle keeps the min and max temperature for 10 minutes respectively. With reference to FIG. 2 showing the pull force results of the contact treated with different cycles, the full force (1232 g) of the contact formed by A3 conductive wire is still higher than 800 g after 1000 temperature cycles, wherein the decreased magnitude (18.5%) of the pull force is smaller than 20% and conforming to the standard. With reference to FIG. 3 which shows the saturation voltage results of the contact treated with different cycles, wherein the contact is formed by A3 conductive wire. The saturation voltage of the contact after 1000 temperature cycles is 2.43, and the increase magnitude (5.65%) of the saturation voltage is smaller than 20%, which means that the increase magnitude of the electric resistance of the contact is smaller than 20% and conforming to the standard. According to the results of temperature cycling test, it can clearly be seen that the aluminum alloy conductive wire of the present invention still presents highly reliability during violent temperature variation.

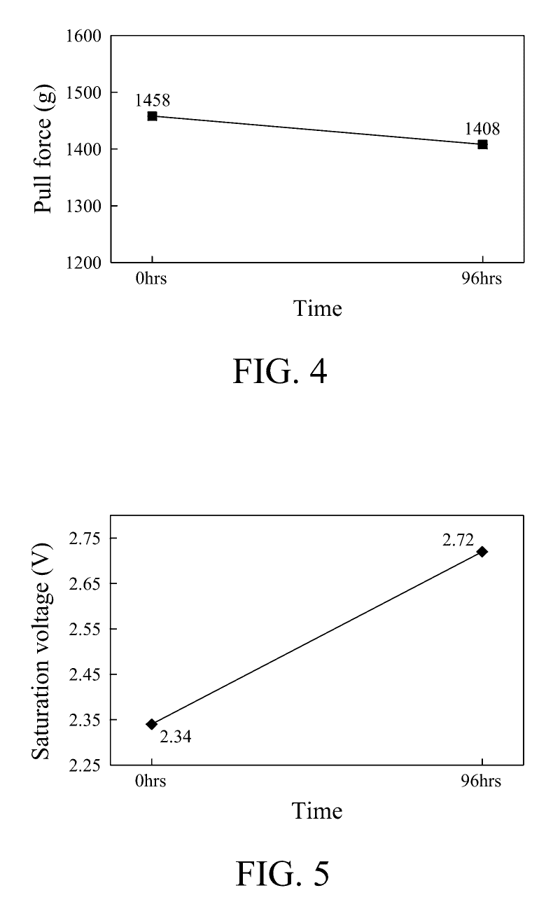

With reference to FIGS. 4 and 5, they are the results of highly accelerated temperature and humidity stress test (HAST, JESDC Standard JESD22-A104D). A3 conductive wire is wire bonded to the pad of the power device for forming the contact firstly, and then the power device with A3 conductive wire after wire bonding is treated in the test of HAST, wherein the temperature, relative humidity and pressure are 130±2° C., 85±5% and 230 KPa respectively. FIGS. 4 and 5 show the results of pull force and saturation voltage of the contact formed by A3 conductive wire respectively, wherein the decrease magnitude of the pull force and the increase magnitude of the saturation voltage are both smaller than 20%, and both conforming to the standard. According to the results of the highly accelerated temperature and humidity stress test, it can be seen that the aluminum alloy conductive wire of the present invention still present highly reliability under high temperature and high humidity condition.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. An aluminum alloy conductive wire consisting of 0.5 to 1.0 wt % iron (Fe), 0.05 to 0.3 wt % copper (Cu) and the balance aluminum (Al) plus incidental impurities.

2. The aluminum alloy conductive wire in accordance with claim 1, wherein the conductivity of the aluminum alloy conductive wire is equal or higher than 62% IACS.

3. The aluminum alloy conductive wire in accordance with claim 1, wherein the conductivity of the aluminum alloy conductive wire is between 62 and 62% IACS.

4. The aluminum alloy conductive wire in accordance with claim 1, wherein the soften temperature of the aluminum alloy conductive wire is equal or higher than 175° C.

5. The aluminum alloy conductive wire in accordance with claim 1, wherein the soften temperature of the aluminum alloy conductive wire is between 175 and 190° C.

6. The aluminum alloy conductive wire in accordance with claim 1, wherein the hardness of the aluminum alloy conductive wire is lower than 35 Hv.
